(19) United States
(12) Patent Application Publication
(10) Pub. No.: US 2010/0219184 A1
(43) Pub. Date: Sep. 2, 2010

(54) APPLICATOR AND METHOD FOR RF HEATING OF MATERIAL

(75) Inventor: Francis Eugene Parsche, Palm Bay, FL (US)

Correspondence Address: HARRIS CORPORATION;C/O MCANDREWS HELD & MALLOY, 500 WEST MADISON, CHICAGO, IL, 60661, US

(73) Assignee: HARRIS CORPORATION, Melbourne, FL (US)

(21) Appl. No.: 12/396,057

(22) Filed: Mar. 2, 2009

(51) Int. Cl. H05B 6/72; H05B 6/74

(52) U.S. Cl. 219/747; 219/761; 219/746; 219/748

(57) ABSTRACT

A radio frequency heater is disclosed including a vessel for containing material to be heated and a radio frequency radiating surface. The vessel has a wall defining a reservoir. The radio frequency radiating surface at least partially surrounds the reservoir. The radiating surface includes two or more circumferentially spaced petals that are electrically isolated from other petals. The petals are positioned to irradiate at least a portion of the reservoir, and are adapted for connection to a source of radio frequency alternating current. A generally conical tank or tank segment having a conically wound radio frequency applicator is also contemplated. Also, a method of heating an oil-water process stream is disclosed. In this method a radio frequency heater and an oil-water process stream are provided. The process stream is irradiated with the heater, thus heating the water phase of the process stream.

### STATEMENT REGARDING FEDERALLY SPONSORED RESEARCH OR DEVELOPMENT

[Not Applicable]

### CROSS REFERENCE TO RELATED APPLICATIONS

This specification is related to McAndrews, Held & Malloy attorney docket numbers:

### 20476US01

### 20478US01

### 20480US01

### 20481US01

### 20483US01

### 20484US01

### 20486US01

### 20487US01

### 20496US01

filed on or about the same date as this specification, each of which is incorporated by reference here.

### BACKGROUND OF THE INVENTION

The disclosure concerns a method and apparatus for application of radio frequency (RF) power to heat material, and more particularly to such a method and apparatus to heat material contained in a vessel.

“Radio frequency” is most broadly defined here to include any portion of the electromagnetic spectrum having a longer wavelength than visible light. Wikipedia provides a definition of “radio frequency” as comprehending the range of from 3 Hz to 300 GHz, and defines the following sub ranges of frequencies:

| Name | Symbol | Frequency | | Wavelength | |
|---|---|---|---|---|---|
| Extremely low | ELF | 3-30 | Hz | 10,000-100,000 | km |
| frequency | | | | | |
| Super low frequency | SLF | 30-300 | Hz | 1,000-10,000 | km |
| Ultra low frequency | ULF | 300-3000 | Hz | 100-1,000 | km |
| Very low frequency | VLF | 3-30 | kHz | 10-100 | km |
| Low frequency | LF | 30-300 | kHz | 1-10 | km |
| Medium frequency | MF | 300-3000 | kHz | 100-1000 | m |
| High frequency | HF | 3-30 | MHz | 10-100 | m |
| Very high frequency | VHF | 30-300 | MHz | 1-10 | m |
| Ultra high frequency | UHF | 300-3000 | MHz | 10-100 | cm |
| Super high | SHF | 3-30 | GHz | 1-10 | cm |
| frequency | | | | | |
| Extremely high | EHF | 30-300 | GHz | 1-10 | mm |
| frequency | | | | | |

Reference is made to U.S. Pat. No. 5,923,299, entitled, “High-power Shaped-Beam, Ultra-Wideband Biconical Antenna.”

### SUMMARY OF THE INVENTION

An aspect of the invention concerns a radio frequency heater comprising a vessel for containing material to be heated and a radio frequency heating antenna or radiating surface (sometimes referred to as an applicator).

The vessel has a wall defining a reservoir. Optionally, the vessel wall can be defined at least in part by the radio frequency radiating surface. The radio frequency radiating surface at least partially surrounds the reservoir. The radiating surface includes two or more circumferentially extending, circumferentially spaced petals that are electrically isolated from other petals. The petals are positioned to irradiate at least a portion of the reservoir, and are adapted for connection to a source of radio frequency alternating current.

Another aspect of the invention is a radio frequency heater including a cyclone vessel having a generally conical wall for containing material to be heated; and a generally conically wound radio frequency radiating conductor running adjacent to the generally conical wall. The conductor is adapted for connection to a source of radio frequency alternating current to heat material disposed within the conical wall.

Another aspect of the invention concerns a method of heating an oil-water process stream, for example a hydrocarbon-water or bitumen-water process stream. In this method a radio frequency heater and an oil-water process stream are provided. A non-limiting example of an oil-water process stream that will benefit from the method is a bitumen-water process stream, produced for example in the course of extracting petroleum or petroleum products from oil sand, oil shale, or other oil formations in which the oil is bound to a mineral substrate. The process stream is irradiated with the heater, thus heating the water phase of the process stream.

Other aspects of the invention will be apparent from this disclosure and the accompanying drawings.

### BRIEF DESCRIPTION OF THE DRAWINGS

FIG. 1 is a schematic perspective view of a radio frequency heater according to an embodiment.

FIG. 2 is a schematic axial section of a radio frequency heater according to an embodiment.

FIG. 3 is a modification of FIG. 5 of U.S. Pat. No. 6,530,484, and shows a schematic side perspective view of another aspect of the disclosure.

FIG. 4 is a sectional diagrammatic view of another aspect of the disclosure.

FIG. 5 is a plan view of the embodiment of FIG. 4.

### DETAILED DESCRIPTION OF THE PREFERRED EMBODIMENTS

The subject matter of this disclosure will now be described more fully hereinafter with reference to the accompanying drawings, in which one or more embodiments of the invention are shown. This invention may, however, be embodied in many different forms and should not be construed as limited to the embodiments set forth herein. Rather, these embodiments are examples of the invention, which has the full scope indicated by the language of the claims. Like numbers refer to like elements throughout.

The inventors contemplate a conical petroleum ore vessel, e.g. a separation vessel, to incorporate a RF heating antenna. Conical structures may have broad utility in materials handling in the form of cyclone separators, flocculation vessels, chutes and the like. An embodiment of the contemplated vessel is a conical horn antenna for RF heating of petroleum ores during processing and separations.

Conical antennas may include the horn type antennas, the biconical dipole antennas, and the biconical loop antenna (U.S. Pat. No. 7,453,414). The conical horn antenna may be formed from a flaring TEM transmission line and be self exciting if the horn walls include driving discontinuities.

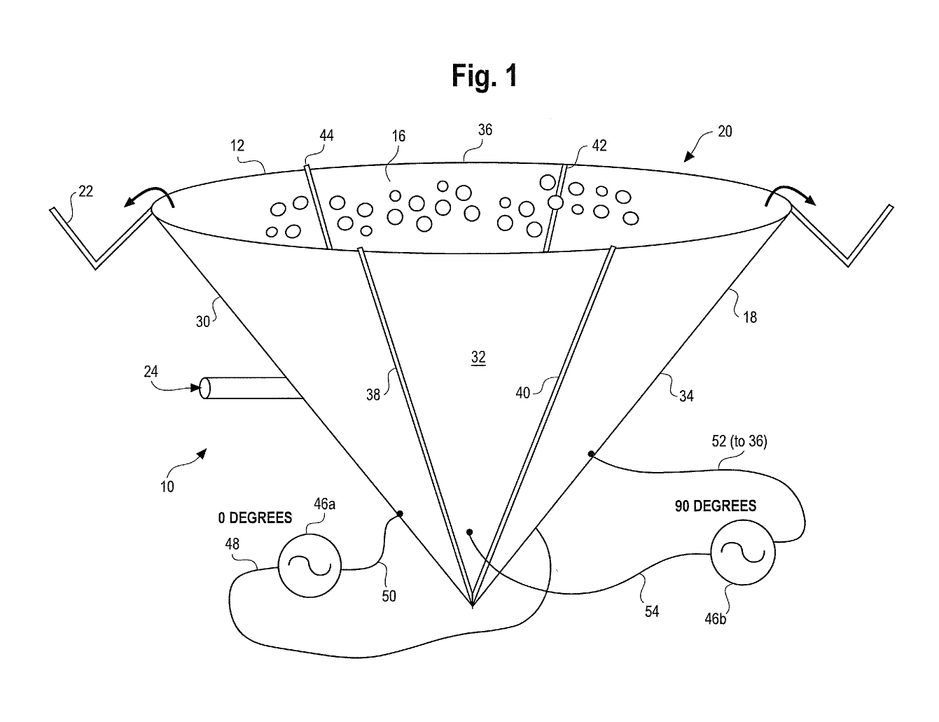

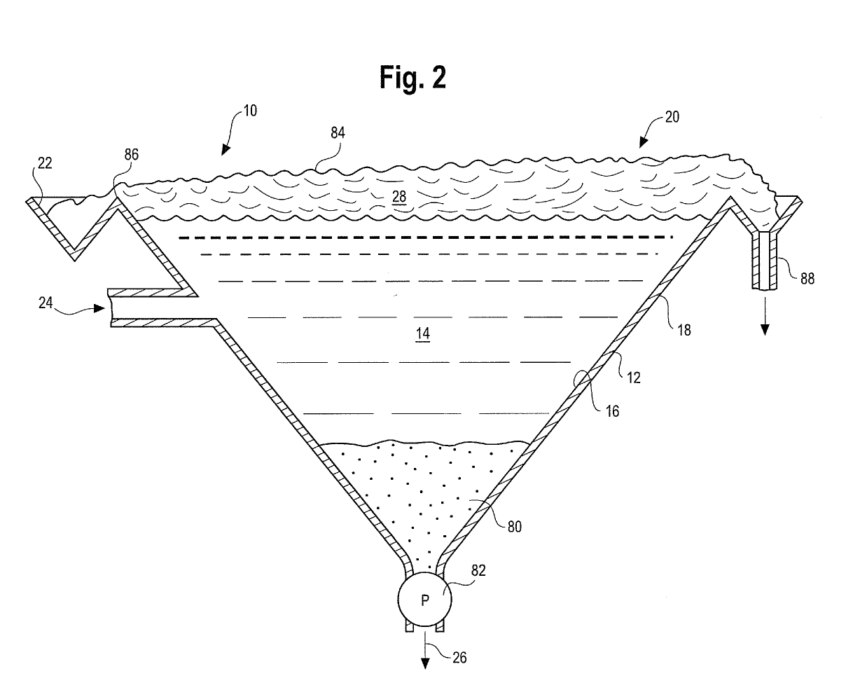

Referring first to FIG. 1, an embodiment of a radio frequency heater 10 is shown comprising a vessel or tank 12 for containing material 14 to be heated (shown in FIG. 2) and a radio frequency radiating surface 16.

The vessel 12 has a wall 18 defining a reservoir 20. In the embodiment illustrated in FIG. 1, the radiating surface 16 is concave. In this embodiment, the radiating surface 16 is at least generally conical. Alternatively, a radiating surface 16 having a cylindrical, hemispherical, parabolic, hyperbolic, polygonal, or other regular or irregular shape can also be used. A conical radiating surface 16 is favored from the point of view of RF energy transfer efficiency. A cylindrical radiating surface 16 may be favored if the radiating surface 16 is supported by or defines a cylindrical process tank.

In the embodiment illustrated in FIG. 1, the reservoir 20 is defined at least in part by the TEM antenna or RF radiating surface 16. The RF radiating surface 16 at least partially surrounds the reservoir 20, defines at least a portion of the vessel wall 18, and in the illustrated embodiment defines essentially the entire vessel wall 18.

In an alternative embodiment, the vessel 12 can be defined by walls partially or entirely within the confines of the radiating surface 16. For example, a vessel made of material that does not strongly absorb the RF radiation emitted by the radiating surface 16 can be located entirely within the radiating surface 16, or its lower or upper portion can be located within the radiating surface 16, while other portions of the vessel are outside the volume enclosed by the radiating surface 16. For another example, the radiating surface 16 can be an interior lining of the vessel wall 18, or a structure partially or entirely within the confines of the vessel wall 18. In short, the vessel 12 and radiating surface 16 can be entirely coextensive, entirely separate, or partially coextensive and partially separate to any relative degree.

In the embodiment illustrated in FIGS. 1 and 2, the vessel 12 further comprises a spillway 22, a feed opening 24, and a drain opening 26. These features adapt the vessel 12 for use as a separation tank to separate froth 28 from the material 14, as explained further below in connection with the description of a material heating process.

The radiating surface 16 includes two or more, here four, circumferentially extending, circumferentially spaced petals 30, 32, 34, and 36 that are electrically isolated from other petals. In the embodiment illustrated in FIG. 1, the conical radiating surface 16 is double bisected to define four petals 30, 32, 34, and 36 mechanically connected by electrically insulating spacers or ribs 38, 40, 42, and 44. The spacers 38, 40, 42, and 44 join the respective petals 30, 32, 34, and 36 in circumferentially spaced, electrically isolated relation. The petals 30, 32, 34, and 36 are positioned to irradiate at least a portion of the reservoir 20, and are adapted for connection to a source 46 of radio frequency alternating current (RF-AC). The conical radiating surface 16 thus defines a near electric field applicator or antenna that also functions as a heating chamber.

While in the illustrated embodiment the petals 30, 32, 34, and 36 extend the full height of the vessel, and are positioned side-by-side, it will be appreciated that the petals could extend only along a lower portion of the vessel, or only along an upper portion of the vessel, or only along a middle portion of the vessel. Moreover, one set of petals could form or follow the upper portion of the vessel and another set of petals could form or follow the lower portion of the vessel. This could be done to apply different amounts of RF energy to different depths or other portions of the tank, as desired for the process. For example, in the separation process to be described, it may be desired to more strongly heat the middle portion of the vessel, above the inert rock and water settling to the bottom and at or below the foam rising to the top.

In the embodiment illustrated in FIG. 1, a source 46 (shown as separate sources 46A and 46B) of multiphase RF-AC, here four-phase RF-AC, is fed to the petals 30, 32, 34, and 36 via plural conductors 48, 50, 52, and 54 electrically connected to the petals 30, 32, 34, and 36. The multiphase RF-AC may be two-phase, three-phase, four-phase, five-phase, six-phase, 12-phase, or any other number of phases. In the embodiment illustrated in FIG. 1, the RF-AC fed to each petal such as 30 is 360/x degrees out of phase with respect to the alternating current fed to each adjacent petal, in which x is the number of phases of the multiphase radio frequency alternating current. Here, the RF-AC is four-phase, so x=4. Each petal such as 30 is 90 degrees out of phase with respect to the following petal such as 32 and the preceding petal such as 36, and 180 degrees out of phase with respect to the opposed petal such as 34, so the application of RF current provides a traveling wave or rotating RF field distribution. This quadrature phasing of the cone petals ensures even heating by forming a rotating, traveling wave distribution of currents and electromagnetic fields.

It will be appreciated that the number of petals and the number of phases of the multiphase RF-AC do not need to be equal, nor do all the petals 30, 32, 34, and 36 need to be out of phase with each other, nor do the phase differences between respective petals need to be the same, nor do all the petals need to be fed RF-AC at any given time.

The source of RF-AC can be configured to provide RF-AC current having a voltage, frequency, and power adapted to heat the contents 14. Particularly contemplated in the present context is a frequency within the more energetic radio frequency range of 300 MHz to 300 GHz, such as UHF, VHF, and EHF radiation, although operative ranges outside these values are contemplated. More preferred for the present purposes is a frequency within the range of from 300 MHz to 3 GHz, although operative frequencies outside these values are contemplated. The amount of power irradiated into the reservoir 20 depends on such factors as the mass and absorbance spectrum of the material 14 to be heated or components of the material 14, the frequency of the RF, the material temperature(s) before and during the process, and the desired heating rate. The use of a near field applicator allows the use of relatively low RF frequencies, which penetrate the material 14 better than higher frequencies.

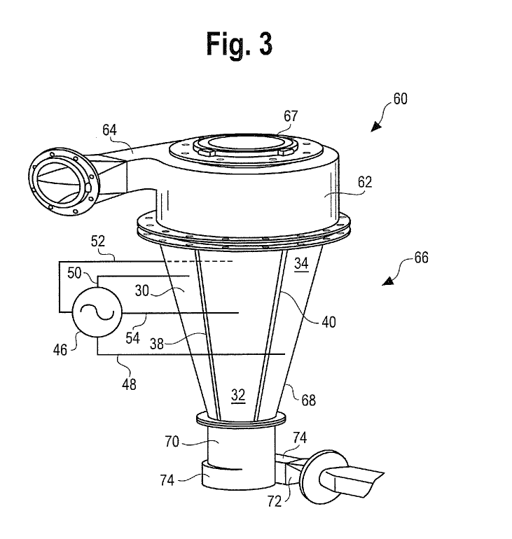

The radio frequency heater can alternatively be adapted for use in many other types of equipment, for example the cyclone separator 60 shown in FIG. 3. FIG. 3 is modified from FIG. 5 of U.S. Pat. No. 6,530,484, all of which is incorporated here by reference.

Referring to FIG. 3, the cyclone 60 comprises an inlet chamber 62 having a tangential inlet 64. Raw feed introduced into the inlet chamber 62 through the tangential inlet 64 will swirl circularly in the inlet chamber 62, resulting in a separation of denser (high gravity) material from less dense (low gravity) material. The denser material moves to the outer peripheral zone of the inlet chamber 62 and downward into the coaxial section 66, while the less dense material reports toward the axis of the inlet chamber 62 at a vortex formed by the swirling motion and upward, and is output from the low-gravity outlet 67.

A conical section 68 of the coaxial section 66 extends from the inlet chamber 62 and terminates in a generally cylindrical outlet chamber 70. A high gravity fraction outlet 72 for the high gravity fraction of separated material is disposed in the outlet chamber 70, and will be arranged generally tangentially relative to the periphery of the outlet chamber 70, the arrangement being one wherein the outlet faces into the stream of particles rotating in the outlet chamber 70. An evolute structure 74 is provided at the underflow high gravity fraction outlet 72 of the cyclone 60. The evolute structure 74 spirals outwardly from the outlet chamber 70 through about 180 degrees, and merges with the generally tangential high gravity fraction outlet 72 for the coarse fraction of material.

The RF heating apparatus in the cyclone of FIG. 3 is analogous to the corresponding structure of FIGS. 1 and 2, bears corresponding reference characters, and is not separately described here. RF heating can be used in this embodiment, for example, to prevent a gaseous, RF-absorbing fraction from condensing in the coaxial section 66. This will assist in directing the RF-absorbing fraction to the outlet 67 instead of the outlet 72.

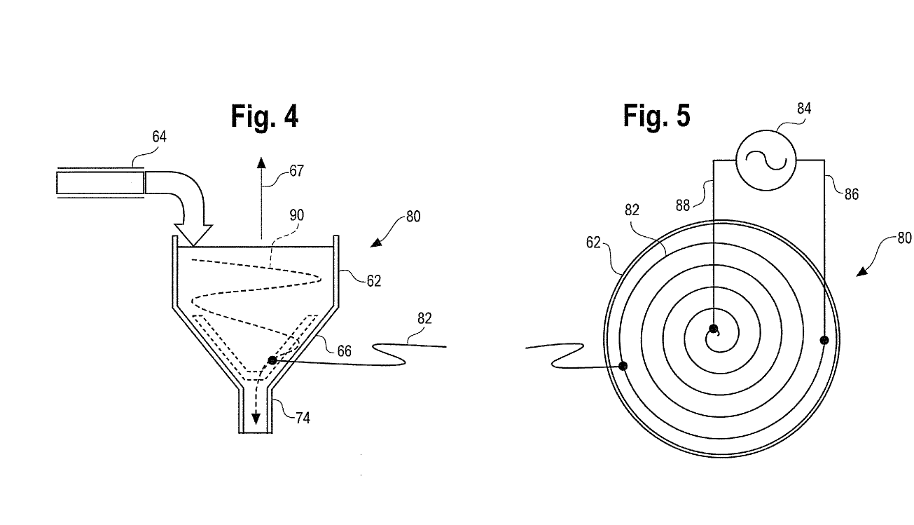

A variation on the applicator of FIG. 3 is shown in FIGS. 4 and 5. The cyclone 80 comprises an inlet chamber 62 having a tangential inlet 64. Raw feed introduced into the inlet chamber 62 through the tangential inlet 64 will swirl circularly in the inlet chamber 62, resulting in a separation of denser (high gravity) material from less dense (low gravity) material. The denser material moves to the outer peripheral zone of the inlet chamber 62 and downward into the coaxial section 66, while the less dense material reports toward the axis of the inlet chamber 62 at a vortex formed by the swirling motion and upward, and is output from the low-gravity outlet 67.

In the embodiment of FIGS. 4 and 5, the applicator 82 is a conically wound conductor, which can be for example a Litz conductor as shown in U.S. Pat. No. 7,205,947, incorporated by reference here. The applicator 82 preferably is wound downward from the peripheral edge to the center in the direction of flow of material from the tangential inlet 64, to reduce the effect of the applicator 82 on flow within the coaxial section 66. The applicator 82 is fed with RF alternating current from a power source 84 via feed conductors 86 and 88 attached to the central and peripheral ends of the applicator 82. A contemplated advantage of this embodiment is that the swirling fluid generally indicated as 90 is always close to a portion of the applicator 82 in the coaxial section 66, tending to evenly heat the fluid 90.

Another aspect of the disclosure concerns a method of heating an emulsion, dispersion, froth or slurry, referred to generally as a process stream. In this method a radio frequency heater 10, such as shown in FIGS. 1 and 2, and an oil-water process stream, for example a bitumen-water process stream (the material 14) are provided. A non-limiting example of an oil-water process stream that will benefit from the method is a bitumen-water process stream 14, produced for example in the course of extracting petroleum or petroleum products from oil sand, oil shale, or other oil formations in which the oil is bound to a mineral substrate. The process stream can include additives in the water, such as sodium hydroxide added to separate the bitumen from sand, clay, or other substrates.

The process stream 14 is irradiated with the heater 10, thus heating the water phase of the process stream. The heater selectively heats the water in the oil-water process stream, as the bitumen oily phase and the mineral substrate do not strongly absorb the RF-AC radiated into the material 14. The bitumen phase is not strongly heated because it has a low dielectric dissipation factor, so it is relatively resistant to dielectric heating; a near-zero magnetic dissipation factor, so it is not subject to magnetic moment heating; and near-zero electrical conductivity, so it is not subject to resistance heating. The water in the process stream thus serves as an RF susceptor, receiving the RF-AC and effectively converting it to heat.

The phases of process stream can be very close together (a typical emulsion has a dispersed phase particle diameter of roughly one micron or less, though “emulsion” is more broadly defined here to include a dispersed particle size of less than 500 microns, alternatively less than 200 microns, alternatively less than 100 microns, alternatively less than 50 microns, alternatively less than 10 microns, alternatively less than 5 microns). Process streams with larger particles, such as the sand in an ore-water slurry, are also contemplated. Assuming a 1-micron dispersed phase, the heat generated in the surrounding water only needs to be conducted about 0.5 microns from the outsides to the centers of the particles or droplets of a dispersed phase. The water is very heat-conductive, has a high heat capacity, and absorbs RF energy directly, so conductance through the water to other components is rapid.

Referring again to FIG. 2 in particular, the separation process carried out there is described in more detail, with reference to separation of bitumen, petroleum, or their cracked products from mined oil sand ore or other bitumen ore (broadly defined to include oil sand, oil shale, and other such ores yielding petroleum products).

The mined oil sand ore, produced for example by strip mining a formation, is sand coated with water and bitumen. The ore is combined with water and agitated to produce a sand/water slurry comprising bitumen carried on the sand. Additives, such as lye (sodium hydroxide) are added to emulsify the water and the bitumen.

The slurry is introduced to the vessel 12 via the feed opening 24, adding to the body of material 14. In the vessel 12, the sand fraction 80 of the material 14 is heavier than the water medium. The sand fraction and excess water drop to the bottom of the vessel 12 to form a sand slurry 80 that is removed through the drain opening or sand trap 26. A slurry pump 82 is provided to positively remove the sand slurry 80.

The bitumen fraction of the material 14 is lighter than the water medium. The bitumen fraction is floated off of the sand and/or is emulsified in the water and rises to the top of the slurry. Agitation optionally can be provided in at least the upper portion of the vessel 12, forming bubbles that float the bitumen-rich fraction upward. The top fraction 28 is a froth comprising a bitumen-rich fraction dispersed in water, which in turn has air dispersed in it. The froth is richer in bitumen than the underlying material 14, which is the technical basis for separation.

In an embodiment, the froth 28 and the water in the material 14 are selectively heated by RF-AC radiation as described above. The bitumen and sand are not directly heated, as they have little absorbance for RF-AC, but the water strongly absorbs the RF-AC and is efficiently heated. The heating of the bitumen/water process stream can also be increased by adding a susceptor other than water—an RF-AC absorbent particulate or fibrous material distributed in the material 14, as described in specifications incorporated by reference above.

The application of heat and agitation to the bitumen/water process stream tends to reduce the viscosity of the bitumen and generate a froth to which separated bitumen particles adhere, forming a bitumen froth. The bitumen froth rises to the top of the vessel 12. The heat in the bitumen froth carried over to the particle separation processes eases separation of foreign particles such as clay in particle settling or centrifuging apparatus.

The bitumen-rich froth 28 is forced upward by the entering material 14 until its surface 84 rises above the weir or lip 86 of the vessel 12. The weir 86 may encircle the entire vessel 12 or be confined to a portion of the circumference of the vessel 12. The froth 28 rising above the level of the weir 86 flows radially outward over the weir 86 and down into the spillway 22, and is removed from the spillway 22 through a froth drain 88 for further processing.

It is contemplated that an analogous process employing the application of RF-AC heating can be used in a wide variety of different industrial processes and equipment, such as separation, flocculation, gravity separation of liquids, reaction vessels, etc.

An advantage of RF-AC heating is that it only heats certain materials that absorb it strongly, so energy is not wasted heating other materials, even if they are in close proximity to the materials intended to be heated.

Another advantage is that heat is provided in a controlled fashion not involving nearby combustion of fuel. The vessel 12 or a feed pipe is occasionally breached, since the material 14 is chemically corrosive (containing lye) and physically corrosive (containing sand). If the vessel 12 were heated by a flame or flue gases fed with fossil fuel, and a large quantity of bitumen contacted the flame due to a breach or otherwise, the result could be a substantial fire. For this reason, open flame heating is desirably avoided.

Also, RF-AC energy heats all the water in the material 14, not just the material nearest the source of heat. More uniform heating is thus provided.

Moreover, unlike steam injection, RF-AC heating does not add additional water to the material being heated. In the case of heating a slurry of bituminous ore in water, the addition of more than a minimal amount of water is undesirable, as such water needs to be separated and processed so it can be disposed of in an environmentally acceptable way. The same is true of many other industrial processes in which water used in the process needs to be removed, and in some cases treated, before being released to the environment.

1. A radio frequency heater comprising:
a vessel for containing material to be heated, the vessel having a wall defining a reservoir; and
a radio frequency radiating surface at least partially surrounding the reservoir, the radiating surface comprising a plurality of circumferentially extending, circumferentially spaced petals that are electrically isolated from other petals and positioned to irradiate at least a portion of the reservoir, the petals being adapted for connection to a source of radio frequency alternating current.

2. The radio frequency heater of claim 1, in which the radiating surface defines at least a portion of the vessel wall.

3. The radio frequency heater of claim 1, further comprising a source of multiphase radio frequency alternating current fed to the petals via plural conductors electrically connected to the petals.

4. The radio frequency heater of claim 3, in which the radio frequency alternating current fed to each petal is 360/x degrees out of phase with respect to the alternating current fed to each adjacent petal, in which x is the number of phases of the multiphase radio frequency alternating current.

5. The radio frequency heater of claim 3, in which the source of alternating current provides current having a frequency and power adapted to heat liquid water.

6. The radio frequency heater of claim 1, in which the reservoir is defined at least in part by the radiating surface.

7. The radio frequency heater of claim 1, in which the radiating surface is concave.

8. The radio frequency heater of claim 7, in which the concave radiating surface is at least generally conical.

9. The radio frequency heater of claim 1, in which the petals are mechanically connected by electrically insulating spacers.

10. The radio frequency heater of claim 1, comprising four petals, joined in circumferentially spaced, electrically isolated relation.

11. The radio frequency heater of claim 1, the vessel further comprising a spillway.

12. The radio frequency heater of claim 1, the vessel further comprising a feed opening and a drain opening.

13. The radio frequency heater of claim 1, in which the reservoir is at least generally conical.

14. The radio frequency heater of claim 1, in which the reservoir is adapted for use as a separation tank.

15. The radio frequency heater of claim 1, in which the reservoir is adapted for use as a cyclone separator.

16. A method of heating a bitumen/water process stream, comprising:
providing a radio frequency heater:
providing a bitumen/water process stream; and
irradiating the process stream with the heater, thus heating the water phase of the process stream.

17. The method of claim 16, in which the process stream comprises bitumen ore dispersed in water.

18. A radio frequency heater comprising:
a cyclone vessel having a generally conical wall for containing material to be heated; and
a generally conically wound radio frequency radiating conductor running adjacent to the generally conical wall, the conductor being adapted for connection to a source of radio frequency alternating current to heat material disposed within the conical wall.
